(19) United States
(12) Patent Application Publication
(10) Pub. No.: US 2019/0065789 A1
(43) Pub. Date: Feb. 28, 2019

(54) DEVICE AND METHOD FOR POWER SOURCE BASED DEVICE AUTHENTICATION

(71) Applicant: MOTOROLA SOLUTIONS, INC., Schaumburg, IL (US)

(72) Inventors: Andrew GONCHAR, Givataim (IL); David LEV, Shoham (IL); Nir DUAN, Shoham (IL); Irakliy PAPIASHVILY, Ashkelon (IL)

(21) Appl. No.: 15/689,335

(22) Filed: Aug. 29, 2017

(51) Int. Cl. G06F 21/81; G06F 21/30; G06F 1/26; G06F 3/06

(52) U.S. Cl. CPC G06F 21/81; G06F 21/30; G06F 3/068; G06F 3/065; G06F 3/0619; G06F 1/266

(57) ABSTRACT

A device and method for power source based device authentication is provided. The device comprises: a power interface configured to receive power from an external power source; a detector configured to detect a characteristic of the power received by the power interface; and a controller. When the characteristic of the power matches an authorized characteristic, the controller implements an authorization process to provide access to the device. When the characteristic of the power does not match the authorized characteristic, the controller implements a deny-authorization process to deny access to the device.

### BACKGROUND OF THE INVENTION

A security problem associated with devices is that they may be stolen by malicious users in order to obtain sensitive data stored on the devices. Such a security problem may be especially acute with public safety devices, for example laptops, mobile devices and the like, used by police organizations, health organizations, intelligence organizations, military organizations, government organizations, and the like, storing sensitive data. Most techniques used to detect if a device has been stolen depend on embedded software and/or hardware mechanisms, such as passwords, fingerprint detection, global positioning system devices, and the like, however many of these techniques may be cracked and/or are ineffective unless a connection to the Internet is available. For example, when a stolen device is placed in Faraday Cage, the device cannot wirelessly connect to the Internet.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a location that includes a device coupled to an external power source via an outlet in accordance with some embodiments.

FIG. 2 is a schematic diagram of a device configured for power source based device authentication in accordance with some embodiments.

FIG. 3 is a flowchart of a method of power source based device authentication in accordance with some embodiments.

FIG. 4 depicts the device of FIG. 2 determining a match between a detected characteristic of power received from an external power source, and an authorized characteristic in accordance with some embodiments.

FIG. 5 depicts the device implementing an authorization process in accordance with some embodiments.

FIG. 6 depicts the device implementing a deny-authorization process in accordance with some embodiments.

FIG. 7 depicts the device of FIG. 2 determining that there is no match between a detected characteristic of power received from an external power source, and an authorized characteristic in accordance with some embodiments.

FIG. 8 depicts the device of FIG. 2 provisioning an authorized characteristic in accordance with some embodiments.

FIG. 9 depicts the device in an unauthorized location and implementing a deny-authorization process in accordance with some embodiments.

FIG. 10 depicts the device of FIG. 2 determining that there is no match between a detected characteristic of power received from an external power source, and an authorized characteristic, and erasing a memory in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

An aspect of the specification provides a device comprising: a power interface configured to receive power from an external power source; a detector coupled to the power interface, the detector configured to detect a characteristic of the power received by the power interface; and a controller coupled to the detector, the controller configured to: when the characteristic of the power matches an authorized characteristic, implement an authorization process to provide access to the device; and when the characteristic of the power does not match the authorized characteristic, implement a deny-authorization process to deny access to the device.

Another aspect of the specification provides a method comprising: receiving, at a controller of a device, a characteristic of power, the characteristic received from a detector coupled to the controller and a power interface, the detector configured to detect the characteristic of the power received by the power interface from an external power source, the device comprising the controller, the detector and the power interface; when the characteristic of the power matches an authorized characteristic, implementing, using the controller, an authorization process to provide access to the device; and when the characteristic of the power does not match the authorized characteristic, implementing a deny-authorization process to deny access to the device.

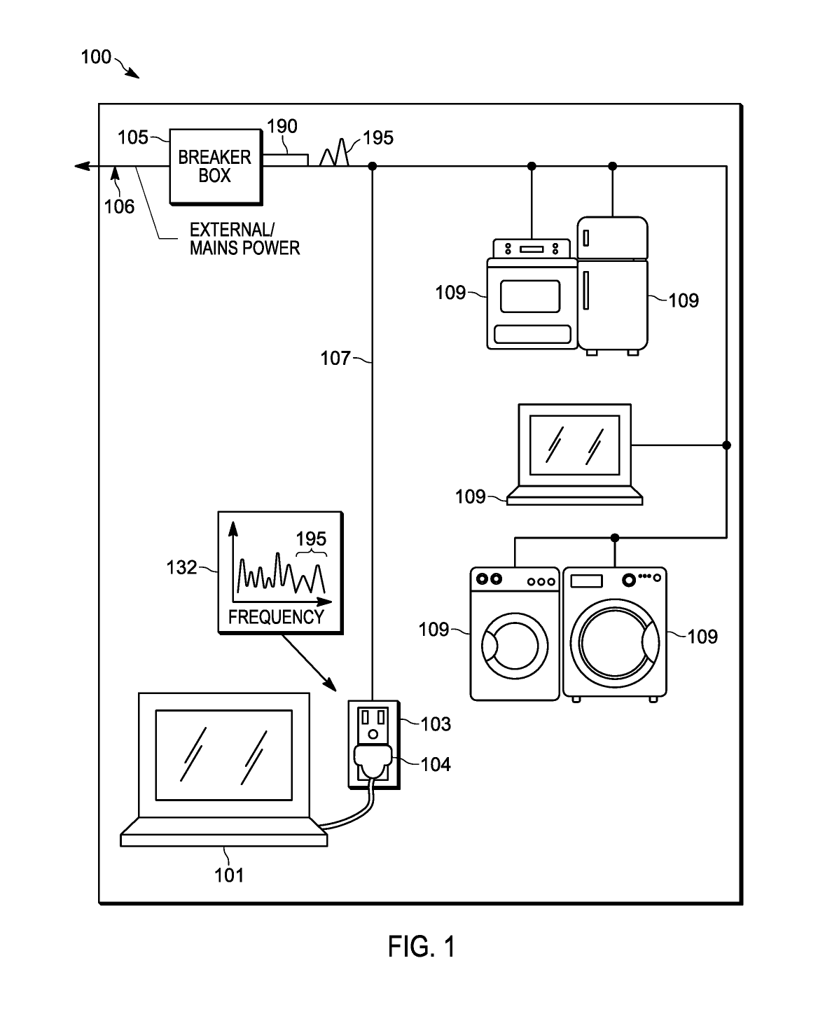

FIG. 1 is a diagram of a location 100 where a device 101 is located, the device 101 configured for power source based device authentication as described in detail below. The device 101 is plugged into a power outlet 103 (e.g. via a plug 104 and an associated cable) that is connected to a breaker box 105 via electrical wiring 107 in the location 100. Furthermore, the breaker box 105 is connected to an external power source 106, including, but not limited to, a mains power source. Hence, the device 101 may be described as being powered by an external power source, and specifically, as depicted, a mains power source. In other words, while the device 101 may alternatively be powered by a battery, and the like, the device 101 relies on being coupled to an external power source at least for charging of the battery and/or for use when the battery is low on stored energy and/or not present. Hence, if the device 101 is stolen, the device 101 is coupled to another external power source for operation.

As depicted in FIG. 1, various electrical devices 109 in the location 100 are also receiving power from the external power source 106 via the electrical wiring 107. As depicted, the electrical devices 109 include a television, a washer, a dryer, a stove, and a refrigerator, however any other electrical device that may be powered by electrical wiring and/or an external power source is within the scope of present embodiments. Indeed, in some embodiments, the location 100 may have no other electrical devices 109 coupled to the external power supply 106 other than the device 101.

As depicted, the location 100 may include a house, an apartment, and the like, and the devices 101, 109 are located in the house, the apartment and the like. Alternatively, the device 101 may be transported to other locations, and coupled to another external power source using respective electrical wiring, with other electrical devices, including, but not limited to, an office and the like.

One or more of the devices 101, 109 generally produce signals, and the like, in the electrical wiring 107. For example, the devices 101, 109 may each generate a specific set of frequencies, and the like, in the electrical wiring 107 due to the various respective circuits in each of the devices 101, 109 which interact with the electrical wiring 107. Furthermore, the signals generated by the devices 101, 109 may be further modified and/or attenuated by the electrical wiring 107 and/or the breaker box 105, for example due to impedance differences within the electrical wiring 107, signal reflections and the like. Such signals may include, but are not limited to, conducted emissions and the like, as well as electrical pulses (e.g. according to a respective frequency), harmonics, and the like. Indeed, such signals may be a function of time and/or be a function of frequency.

For example, when a function of time, the signals may repeat over a given time period, for example according to a respective periodicity of each of the device 109, and/or when a function of frequency the signals may include specific frequencies at respective amplitudes.

Hence, power received at the device 101 from the external power source 106 generally includes an “electrical fingerprint” and/or a characteristic 132 as represented in FIG. 1 by a graph, which depicts amplitude of signals, as a function of frequency, of the external power source 106 detectable at the device 101 via the electrical wiring 107. However, the “electrical fingerprint” and/or characteristic 132 may alternatively be represented as a function of time, assuming the signals repeat over a given time period (e.g. according to respective periodicities of signals of the devices 101, 109).

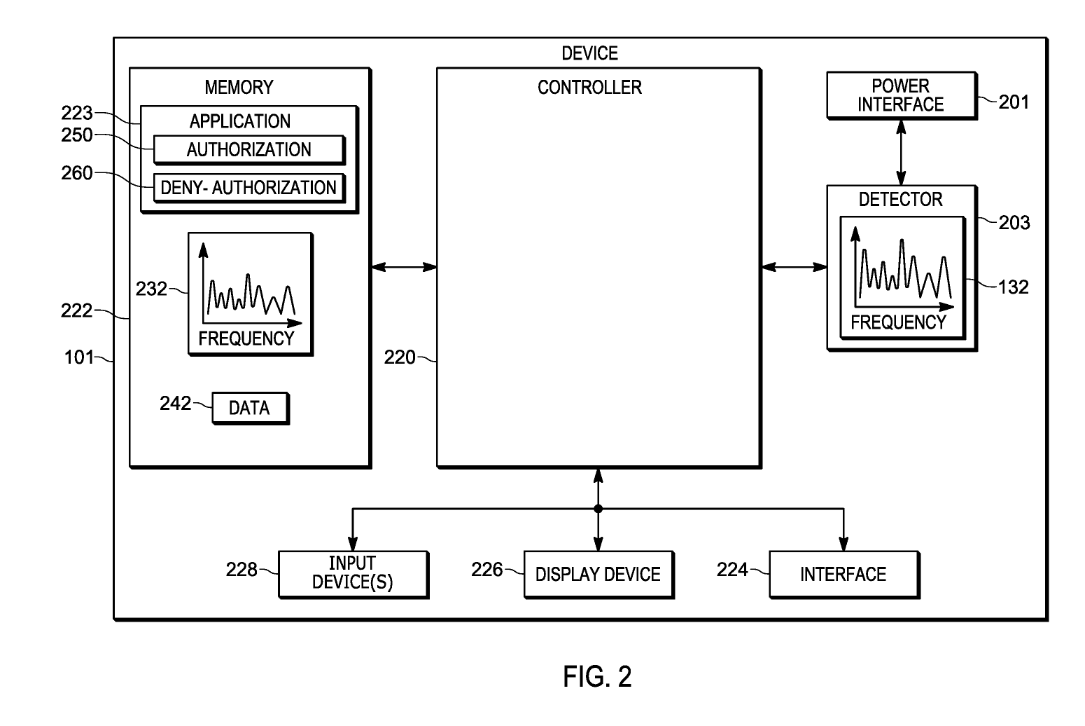

For example, with reference to FIG. 2, the electrical fingerprint and/or characteristic 132 may comprise one or more of an electrical signal present in the power received at a power interface 201 of the device 101, a current (e.g. electrical current) pattern of the power received at the power interface 201, a voltage pattern of the power received at the power interface 201, a frequency pattern of the power received at the power interface 201, and the like.

Such an electrical fingerprint and/or characteristic 132 may be unique for a given location and/or a given house, apartment, and the like. As described herein the terms “characteristic” and “electrical footprint” will be used interchangeably and may be understood to mean at least one characteristic detectable in power received by an external power source that may be unique for a given location.

Indeed, in general, two similar devices 109 (for example two televisions of the same model), and/or devices 101, may one or more of emit different electrical characteristics and/or have a different electrical characteristic on different electrical wiring systems (e.g. due to respective different impedances etc.). Hence, the electrical characteristic of a location may generally be unique to that location.

Furthermore, even when the device 101 is the only electrical device coupled to electrical wiring at a location, the electrical fingerprint and/or the characteristic of power received at the power interface 201 will be different at different locations.

Similarly, the power received from the external power source 106 may include a signal representative of one or more of a type and an identifier associated with the external power source 106. For example, when the external power source 106 includes a local step-down transformer (e.g. located near the location 100), the local step-down transformer may emit a signal that is particular to the step-down transformer, and/or particular to a type of the step-down transformer and/or which identifies the step-down transformer. Hence, the characteristic 132 may include an indication of one or more of a type and an identifier associated with the external power source 106, for example a given set of frequencies produced by a local step-down transformer.

As also depicted in FIG. 1, the location 100 may include an optional emitter device 190 coupled to the electrical wiring 107, for example adjacent the breaker box 105 and/or in the breaker box 105, the emitter device 190 emitting a signal 195 representative of one or more of a type and an identifier associated with the emitter device 190.

Hence, the characteristic 132 may include an indication of one or more of a type and an identifier produced by the optional emitter device 190 and which may be associated with the external power source 106 when detected by the device 101.

Indeed, the optional emitter device 190 may be specifically installed in the location 100 to provide a characteristic and/or signal detectable by the device 101 as a characteristic of the external power source 106. When a user of the device 101 wants to designate their home and/or office as an authorized and/or authenticated location for using the device 101, the optional emitter device 190 may be installed in the electrical system of the home or office to supplement detection of a characteristic of power received from a respective power source. In yet further embodiments, the optional emitter device 190 may be plugged into a power outlet. Hence, the characteristic may include an indication of one or more of a type and an identifier associated with the external power source 106 (and/or the optional emitter device 190). Indeed, as depicted, the characteristic 132 includes the signal 195.

In yet further embodiments, the electrical wiring 107 may be coupled to a powerline networking device which adapts the electrical wiring 107 for use as a network, for example to connect to the Internet, and the like. Indeed, the optional emitter device 190 may comprise such a powerline networking device. Either way, a signal emitted by the powerline networking device may also contribute to the characteristic 132.

Such a characteristic 132 may hence be used by the device 101 for authentication, presuming, for example, that the characteristic has been previously stored at the device 101 as an authorized characteristic. In other words, the device 101 is generally enabled to detect a characteristic of power received from an external power source to which the device 101 is coupled, determine whether the characteristic matches an authorized characteristic and either authorize access to the device 101 when a match is found, or deny access to the device 101 when a match is not found, as described hereafter.

As depicted, the device 101 generally comprises a laptop computer, however the device 101 generally comprises any mobile device including, but not limited to, any suitable combination of electronic devices, communication devices, computing devices, portable electronic devices, mobile computing devices, portable computing devices, tablet computing devices, laptop computers, telephones, PDAs (personal digital assistants), cellphones, smartphones, e-readers, mobile camera devices and the like.

In some embodiments, the device 101 is specifically adapted for use as a public safety device and may be deployed and/or managed by a public safety and/or first responder agency including, but not limited to, police organizations, health organizations, intelligence organizations, military organizations, government organizations, and the like.

However, the device 101 may further be adapted for use as a consumer device and/or business device, and the like, and/or may include additional or alternative components related to, for example, telephony, messaging, entertainment, and/or any other components that may be used with computing devices and/or communication devices.

Attention is next directed to FIG. 2 which depicts a block diagram of the device 101. The device 101 comprises: a power interface 201 configured to receive power from an external power source; a detector 203 configured to detect a characteristic of the power received by the power interface 201; and a controller 220 configured to: when the characteristic of the power matches an authorized characteristic, implement an authorization process to provide access to the device 101; and when the characteristic of the power does not match the authorized characteristic, implement a deny-authorization process to deny access to the device 101. In general, the controller 220 is coupled the detector 203, and the detector 203 is coupled to the power interface 201.

As depicted, the device 101 further comprises a memory 222, coupled to the controller 220, the memory 222 storing an application 223, and a communication interface 224, interchangeably referred to hereafter as the interface 224, and optionally a display device 226 and at least one input device 228.

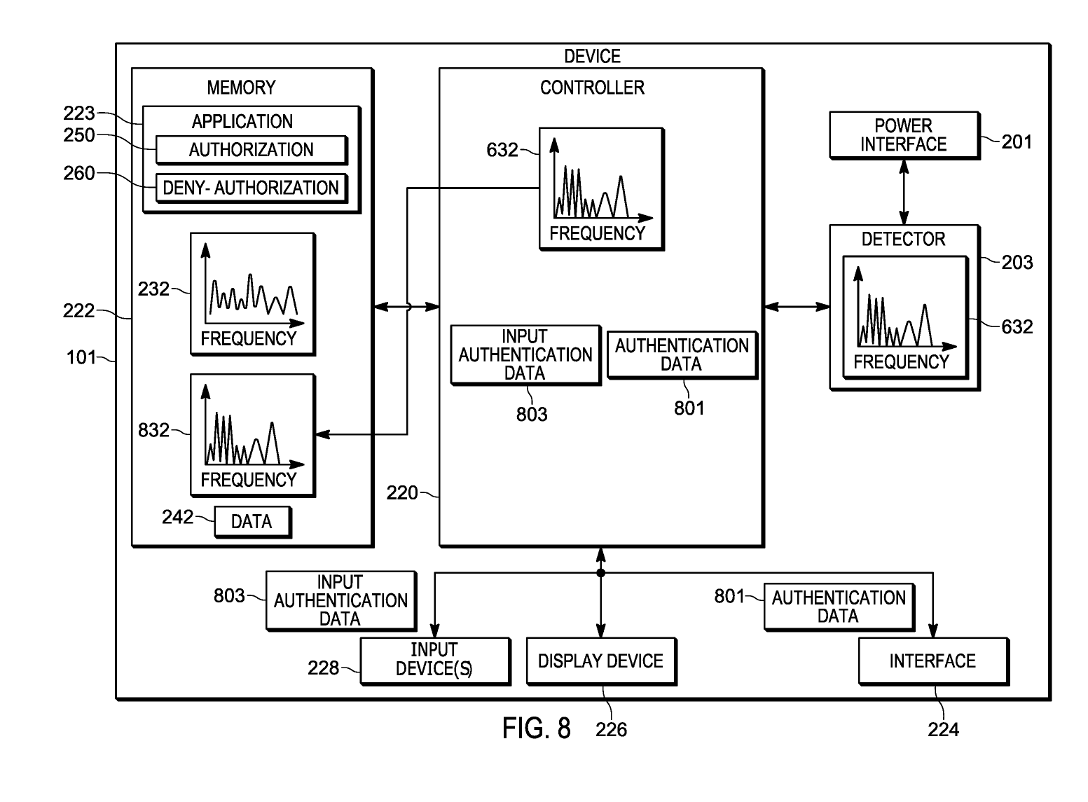

As depicted, the memory 222 further stores an authorized characteristic 232 which may be provisioned at the memory 222 in a provisioning process as described below with reference to FIG. 8. In general, however, assuming that the location of location 100 is a location that is authorized for use with the device 101, the authorized characteristic 232 is similar and/or identical to the characteristic 132. In other words, the characteristic 132 was previously stored at the memory 222 as representing an authorized characteristic.

Furthermore, while the authorized characteristic 232 is represented as a graph similar to the graph representing the characteristic 132, the authorized characteristic 232 may alternatively be represented by any suitable data defining the peaks and/or amplitudes and/or frequencies shown in the depicted authorized characteristic 232. For example, the authorized characteristic 232 may comprise one or more of: data representative of a given electrical signal present in the power received at the power interface 201, a current (e.g. electrical current) pattern of the power received at the power interface 201, a voltage pattern of the power received at the power interface 201, a frequency pattern of the power received at the power interface 201, and the like. Furthermore, the authorized characteristic 232 may include an indication of one or more of a type and an identifier associated with the external power source as described above with reference to the characteristic 132.

As depicted, the memory 222 further stores data 242 which may include, but is not limited to, sensitive data, for example data which has been marked and/or designated as data to be encrypted and/or deleted if the device 101 is stolen as described below; data 242, for example, may be stored in a portion of the memory 222 associated with sensitive data, for example, in a folder which is specifically dedicated to storing sensitive data.

The power interface 201 is generally configured to receive power from an external power source, for example the external power source 106, and may include, but is not limited to, an electric plug, a power converter (e.g. an alternating-current to direct-current (AC-to-DC) converter), a power distribution circuit, power management components, a current limiter, electrical filters and the like. Regardless of a specific hardware configuration, the power interface 201 receives power from the external power source 106 having an electrical footprint and/or a characteristic.

While the power interface 201 is depicted in FIG. 2 as being only in communication with the detector 203, it is understood that power received from the power interface 201 may be used to power all the electrical components of the device 101.

Furthermore, the power received by the power interface 201 may be used to charge a battery (not depicted) of the device 101.

The detector 203 is generally configured to detect a characteristic of the power received by the power interface 201 (e.g. the characteristic 132, as depicted in FIG. 2) and may include, but is not limited to, one or more of: a signal detector, a current detector, a voltage detector, a power detector, and a spectrum analyzer. In particular, the detector 203 may be configured to measure a characteristic of the power received by the power interface 201 as a function of one or more of time and frequency. When the power interface 201 includes a filter for removing unwanted frequencies, for example, the detector 203 may be configured to detect a characteristic of the power received by the power interface 201 prior to any such filtering.

Furthermore, the detector 203 may be configured to time-average signals from the power interface 201 on an on-going and/or periodic basis and provide data representing a detected characteristic of the power received by the power interface 201 to the controller 220, either when requested and/or on a periodic basis.

The detector 203 may be further configured to detect a characteristic of the power received by the power interface 201 over a given time period (e.g. over a time-measurement window) compatible with a periodicity of signals from the devices 109.

The controller 220 includes one or more logic circuits, one or more processors, one or more microprocessors, one or more ASIC (application-specific integrated circuits) and one or more FPGA (field-programmable gate arrays). In some embodiments, the controller 220 and/or the device 101 is not a generic controller and/or a generic device, but a device specifically configured to implement power source based device authentication functionality. For example, in some embodiments, the device 101 and/or the controller 220 specifically comprises a computer executable engine configured to implement specific functionality for power source based device authentication.

The memory 222 is a machine readable medium that stores machine readable instructions to implement one or more programs or applications. Example machine readable media include a non-volatile storage unit (e.g. Erasable Electronic Programmable Read Only Memory (“EEPROM”), Flash Memory) and/or a volatile storage unit (e.g. random access memory (“RAM”)). In the embodiment of FIG. 2, programming instructions (e.g., machine readable instructions) that implement the functional teachings of the device 101 as described herein are maintained, persistently, at the memory 222 and used by the controller 220 which makes appropriate utilization of volatile storage during the execution of such programming instructions.

In particular, the memory 222 of FIG. 1 stores instructions corresponding to the application 223 that, when executed by the controller 220, enables the controller 220 to implement power source based device authentication functionality associated with the application 223. In the illustrated example, when the controller 220 executes the application 223, the controller 220 is enabled to: when the characteristic of the power matches an authorized characteristic (e.g. as indicated by the authorized characteristic 232), implement an authorization process 250 to provide access to the device 101; and when the characteristic of the power does not match the authorized characteristic, implement a deny-authorization process 260 to deny access to the device 101.

As depicted, instructions for each of the authorization process 250 and the deny-authorization process 260 are components of the application 223, however instructions for each of the authorization process 250 and the deny-authorization process 260 may be stored separately from the application 223.

The interface 224 is generally configured to communicate using wired and/or wired links as desired, including, but not limited to, cables, WiFi links and the like. In other words, the interface 224 is enabled to communicate using any suitable combination of wired networks and/or wireless networks. The interface 224 may be implemented by, for example, one or more radios and/or connectors and/or network adaptors, configured to communicate wirelessly, with network architecture that is used to implement one or more communication channels between the device 101 and a wired and/or wireless network. In some embodiments, the interface 224 includes, but is not limited to, one or more broadband and/or narrowband transceivers, such as a Long Term Evolution (LTE) transceiver, a Third Generation (3G) (3GGP or 3GGP2) transceiver, an Association of Public Safety Communication Officials (APCO) Project 25 (P25) transceiver, a Digital Mobile Radio (DMR) transceiver, a Terrestrial Trunked Radio (TETRA) transceiver, a WiMAX transceiver operating in accordance with an IEEE 902.16 standard, and/or other similar type of wireless transceiver configurable to communicate via a wireless network for infrastructure communications. In yet further embodiments, the interface 224 includes one or more local area network or personal area network transceivers operating in accordance with an IEEE 902.11 standard (e.g., 902.11a, 902.11b, 902.11g), or a Bluetooth™ transceiver. In some embodiments, the interface 224 is further configured to communicate “radio-to-radio” on some communication channels, while other communication channels are configured to use wireless network infrastructure. Example communication channels over which the interface 224 may be generally configured to wirelessly communicate include, but are not limited to, one or more of wireless channels, cell-phone channels, cellular network channels, packet-based channels, analog network channels, Voice-Over-Internet (“VoIP”), push-to-talk channels and the like, and/or a combination. Indeed, the term “channel” and/or “communication channel”, as used herein, includes, but is not limited to, a physical radio-frequency (RF) communication channel, a logical radio-frequency communication channel, a trunking talkgroup (interchangeably referred to herein a “talkgroup”), a trunking announcement group, a VOIP communication path, a push-to-talk channel, and the like.

In particular, however, when the device 101 is stolen, the interface 224 may be turned off and/or disconnected from a network (e.g. by a malicious user) to prevent the device 101 from reporting itself as being stolen and/or prevent the device 101 from transmitting alerts, its location, and the like. For example, the device 101 may be placed in a Faraday Cage to prevent wireless communication of the interface 224.

The optional display device 226 comprises any suitable one of, or combination of, flat panel displays (e.g. LCD (liquid crystal display), plasma displays, OLED (organic light emitting diode) displays) and the like, as well as one or more optional touch screens (including capacitive touchscreens and/or resistive touchscreens). The optional input device 228 comprises any suitable one of, or combination of keyboards, pointing devices, touchpads, touchscreens, buttons, and the like. Furthermore, when present, one or more of the display device 226 and the input device 228 may be external to the device 101 and accessible to the device 101 via the interface 224; for example, the display device 226 and/or the input device 228 may be components of a portable personal computer.

While not depicted, the device 101 may further include one or more speakers and/or one or more microphones and/or one or more lights and/or one or more haptic devices and/or one or more notification devices.

In any event, it should be understood that a wide variety of configurations for the device 101 are within the scope of present embodiments.

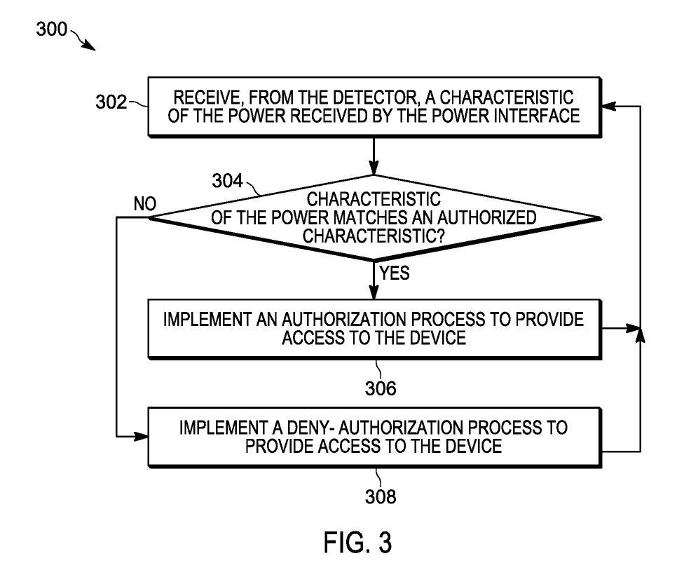

Attention is now directed to FIG. 3 which depicts a flowchart representative of a method 300 for implementing power source based device authentication. In some embodiments, the operations of the method 300 of FIG. 3 correspond to machine readable instructions that are executed by, for example, the device 101 of FIG. 1, and specifically by the controller 220 of the device 101. In the illustrated example, the instructions represented by the blocks of FIG. 3 are stored at the memory 222, for example, as the application 223. The method 300 of FIG. 1 is one way in which the device 101 and/or the controller 220 is configured. Furthermore, the following discussion of the method 300 of FIG. 3 will lead to a further understanding of the device 101, and its various components.

However, it is to be understood that the device 101 and/or the controller 220 and/or the method 300 may be varied, and need not work exactly as discussed herein in conjunction with each other, and that such variations are within the scope of present embodiments.

Furthermore, the method 300 of FIG. 3 need not be performed in the exact sequence as shown and likewise various blocks may be performed in parallel rather than in sequence. Accordingly, the elements of method 300 are referred to herein as “blocks” rather than “steps”.

At a block 302, the controller 220 receives, from the detector 203, the characteristic 132 of the power received by the power interface 201. For example, the controller 220 may receive data from the detector representative of the characteristic 132 as detected by the detector 203, as described above.

At a block 304, the controller 220 compares the characteristic 132 with the authorized characteristic 232 as stored in the memory 222 to determine if the characteristic 132 matches the authorized characteristic 232.

When the characteristic 132 of the power matches the authorized characteristic 232 (e.g. a “YES” decision at the block 304), at a block 306, the controller 220 implements the authorization process 250 to provide access to the device 101.

However, when the characteristic 132 of the power does not match the authorized characteristic 232 (e.g. a “NO” decision at the block 304), at a block 308, the controller 220 implements the deny-authorization process 260 to deny access to the device 101.

In some embodiments, the method 300 is repeated, for example on a periodic basis, such that controller 220 may be configured to repeat comparing the characteristic 132 with the authorized characteristic 232 to repeat a determination of whether to implement the authorization process 250 or the deny-authorization process 260.

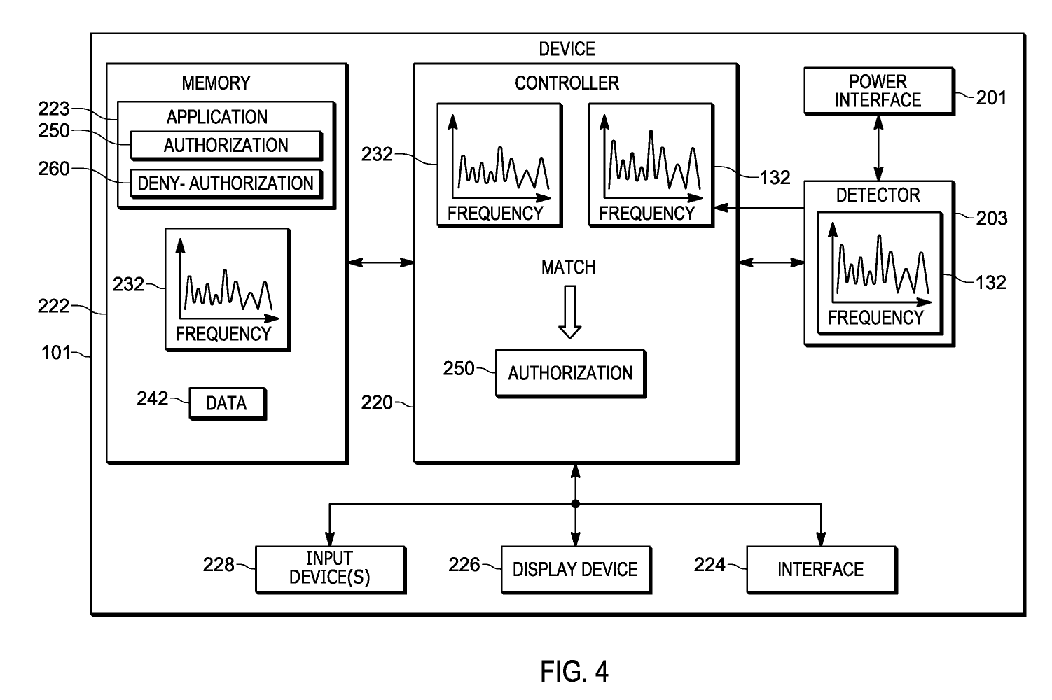

The method 300 will now be described with reference to FIG. 4 to FIG. 10.

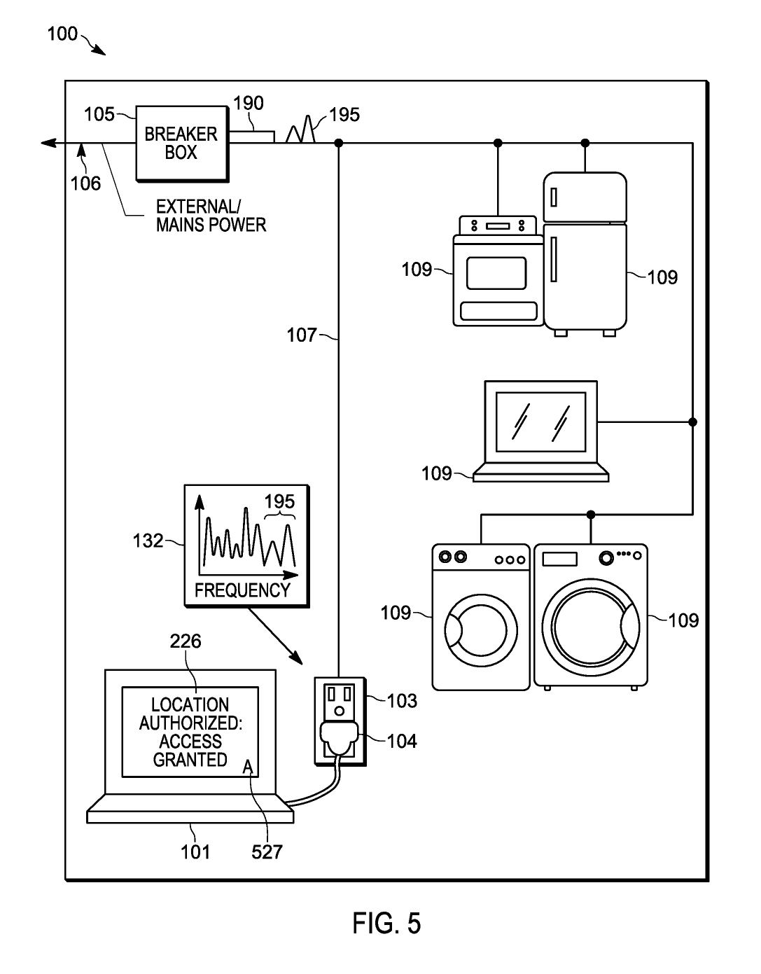

Attention is next directed to FIG. 4, and FIG. 5 which depict an example embodiment of blocks 302, 304 306 of the method 300. FIG. 4 is substantially similar to FIG. 2, with like elements having like numbers, and FIG. 5 is substantially similar to FIG. 1 with like elements having like numbers.

FIG. 4 depicts the controller 220 receiving (e.g. at the block 302 of the method 300) the characteristic 132 as detected by the detector 203, and comparing the characteristic 132 with the authorized characteristic 232 receiving (e.g. at the block 304 of the method 300).

FIG. 4 further depicts the controller 220 determining that the characteristic 132 and the authorized characteristic 232 match (e.g. a “YES” decision at the block 304 of the method 300). The controller 220 may be configured to use any suitable process for comparing the characteristic 132 with the authorized characteristic 232 to determine whether they match. Indeed, a match may be determined when the characteristic 132 with the authorized characteristic 232 do not exactly match. For example, relative positions and/or relative amplitudes of various peaks in frequencies, and the like, of the characteristic 132 and the authorized characteristic 232 may be used to determine a match. Furthermore, the controller 220 may determine that the characteristic 132 matches the authorized characteristic 232 using one or more threshold values and/or confidence threshold values (e.g. as configured at the application 223); for example, if a match between the characteristic 132 and the authorized characteristic 232 is determined within 90% confidence, the controller 220 may determine that the characteristic 132 and the authorized characteristic 232 match.

Furthermore, in embodiments that include the emitter device 190, the controller 220 may be configured to determine a match between the characteristic 132 and the authorized characteristic 232 only when both: a match within a given threshold value and/or confidence level is found; and when the signal 195 is included in the characteristic 132 (e.g. assuming that the signal 195 is also included in the authorized characteristic 232).

As depicted in FIG. 4, the controller 220 determines that the characteristic 132 and the authorized characteristic 232 match and, in response, implements the authorization process 250 (e.g. at the block 306 of the method 300).

The authorization process 250 may include, but is not limited to, granting access to the device 101, unlocking the device 101, decrypting sensitive data 242 (if decrypted), and the like. In other words, once the controller 220 detects that the device 101 is in an authorized location, as determined from the characteristic 132, access to the device 101 is granted and a user may operate and/or interact with the device 101. In some embodiments, the controller 220 may request additional passwords, etc. from the user using the display device 226 and the like.

As depicted in FIG. 5, in some embodiments, the controller 220 may further control the display device 226 (and/or a speaker, a notification device, and the like) to provide a notification of the location being authorized and/or access being granted. For example, as depicted in FIG. 5, the display device 226 is controlled to provide text “LOCATION AUTHORIZED: ACCESS GRANTED”, as well as an icon 527 (e.g. “A”) indicating that access is granted. In some embodiments, however, no indication is provided and/or only an icon, and the like is provided.

Furthermore, the method 300 may be repeated, for example periodically, to continue to determine whether the characteristic 132 continues to match the authorized characteristic 232.

In yet further embodiments, when the device 101 is to be operated on battery power, and not plugged into the outlet 103, upon startup, the controller 220 may be configured to require that the device 101 be nonetheless plugged into an outlet, and the like (and/or coupled to an external power source) to implement the method 300 and verify whether or not the device 101 is in an authorized location. For example, the controller 220 may be further configured to: interrupt a start-up process and control the display device 226 to provide instructions to plug in the device 101; and, when the characteristic 132 is detected, implement the method 300. After access is granted (e.g. at the block 306 of the method 300), the device 101 may be unplugged and operate on battery power. However, the controller 220 may be further configured to periodically interrupt operation of the device 101 to again request that the device 101 be plugged in to again implement the method 300; for example, such interruptions may occur every half hour, every hour, and the like, as configurable, for example, at the application 223.

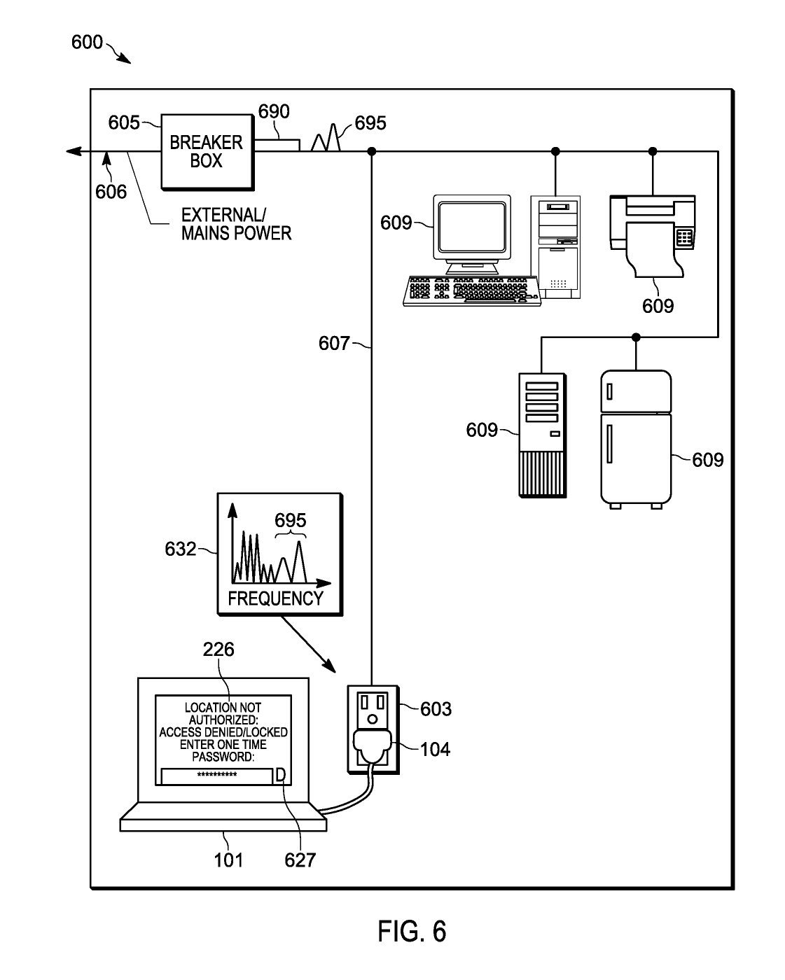

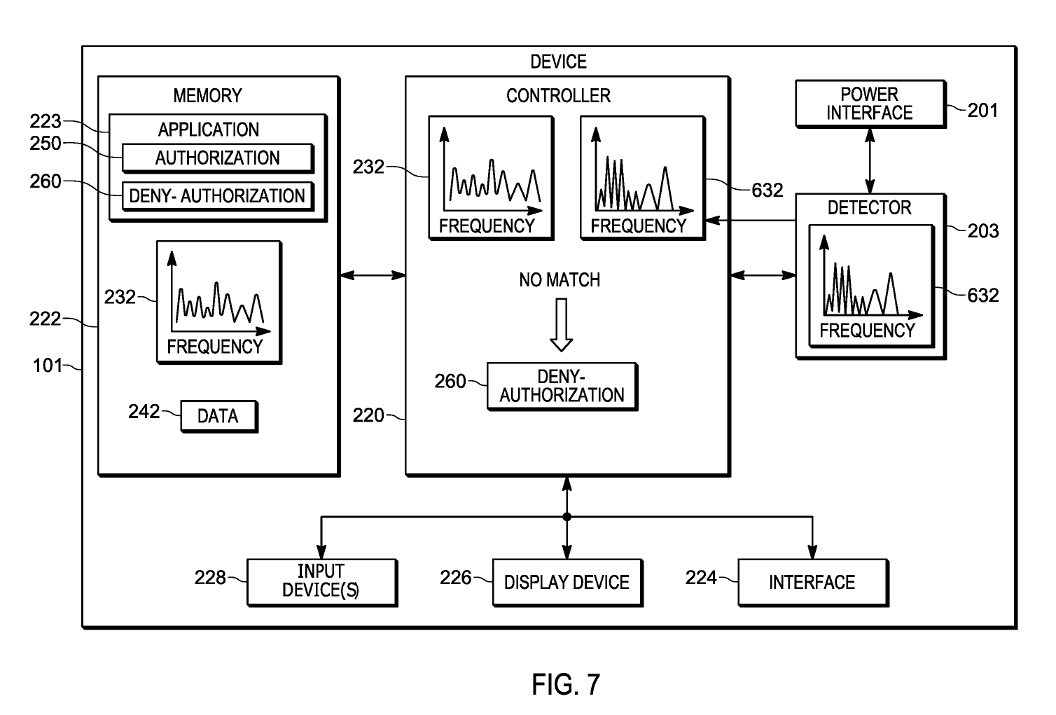

Attention is next directed to FIG. 6, and FIG. 7 which depict an example embodiment of blocks 302, 304, 308 of the method 300. FIG. 7 is substantially similar to FIG. 2 with like elements having like numbers.

In FIG. 6, the device 101 has been transported to another location 600, for example an office of a user of the device 101. The device 101 is plugged into a power outlet 603 (e.g. via the plug 104 and the associated cable) that is connected to a breaker box 605 via electrical wiring 607 in the location 600, and furthermore the breaker box 605 is connected to an external power source 606, for example a mains power source. Furthermore, various electrical devices 609 in the location 600 are also receiving power from the external power source 606 via the electrical wiring 607. As depicted, the electrical devices 609 include a personal computer, a printer, a server and a refrigerator, however any other electrical device that may be powered by electrical wiring and/or an external power source is within the scope of present embodiments. As also depicted in FIG. 6, a characteristic 632 of the external power source 606 is different from the authorized characteristic 232 (e.g. as the authorized characteristic 232 is associated with the external power source 106 of the location 100). In other words, at the location 600, the devices 609, as well as the electrical wiring 607 and different electrical behavior of the device 101 due to the different electrical wiring 607, cause the characteristic 632 to be different from the characteristic 132 at the location 100

As further depicted in FIG. 6, the location 600 further includes an optional emitter device 690, similar to the emitter device 190, emitting a signal 695, which may be the same or different as the signal 195. For example, for given locations at which a user is often located, respective emitter devices 190, 690 may be deployed which emit respective signals 195, 695 selected for association with the device 101.

Regardless, in contrast to the example shown in FIG. 4 and FIG. 5, in the example of FIG. 6, the characteristic 632 does not match the authorized characteristic 232. Indeed, with reference to FIG. 7, the controller 220 compares the characteristic 632 with the authorized characteristic 232 and determines that they do not match (e.g. a “NO” decision at the block 304 of the method 300). Hence, the controller 220 implements the deny-authorization process 260 (e.g. at the block 308 of the method 300).

The deny-authorization process 260 may include, but is not limited to, locking the device 101; turning off the device 101; erasing the memory 222 of the device 101; wiping a hard-drive (e.g. the portion of the memory 222 that includes a hard-drive, when present) of the device 101; encrypting data (e.g. the data 242) at the device 101; providing a notification of an unauthorized location; denying access to one or more of a given function, a given feature and a given application; controlling a notification device (e.g. the display device 226) to request authorization data, and the like.

For example, with further reference to FIG. 6, the controller 220 is implementing the deny-authorization process 260 by: locking the device 101 (e.g. as indicated at the display device 226 using the text “LOCKED”), and controlling the display device 226 (and/or another notification device) to provide a notification of an unauthorized location (e.g. as indicated at the display device 226 using the text “LOCATION NOT AUTHORIZED: ACCESS DENIED”), ”, as well as an icon 627 (e.g. “D”) indicating that access is denied. The controller 220 may be further denying access to a given function, a given feature and given application including, but not limited to a user log-in function and/or feature and/or application, a network access function and/or feature and/or application, and the like.

As also depicted in FIG. 6, the controller 220 may deny access to the device 101, and also initiate a process for authorizing the location 600.

In some embodiments, the controller 220 may optionally transmit an alert of the device 101 being at an unauthorized location using the interface 224, for example to a security server, and the like, which may cause the security server to transmit a one-time password, and/or any other type of authorization data (e.g. a personal identification number and the like), to another device (e.g. a mobile phone, and the like) associated with the user of the device 101. As depicted in FIG. 6, the controller 220 is controlling the display device 226 to request the one-time password and/or authorization data.

Presuming the one-time password and/or authorization data is received at the device 101, for example via the input device 228, the controller 220 may store the characteristic 632 in the memory 222 as a second authorized characteristic.

For example, as depicted in FIG. 8, the controller 220 may receive, via the interface 224, authentication data 801, for example as transmitted by a security server and the like, and input authentication data 803 via the input device 228. As depicted, the input authentication data 803 matches the authentication data 803, and hence, the characteristic 632 associated with the location 600 and/or the external power source 606 is stored in the memory 222 as a second authorized characteristic 832. The method 300 then repeats and at the block 304 the characteristic 632 is compared to both the authorized characteristics 232, 832, and a match is found between the characteristic 632 and the authorized characteristic 832, which cause the authorization process 250 to be implemented as depicted in FIG. 4 and FIG. 5.

Alternatively, the controller 220 may transmit the input authentication data 803 to the security server which performs the comparison, and in response transmits an authorization command, and the like, when a match is determined.

Hence, FIG. 6 and FIG. 8 further depict a process for provisioning an authorized characteristic at the memory 222. In particular, the controller 220 may be further configured to (e.g. when implementing the application 223) to: receive, using an input device 228, authorization data for providing access to the device 101; when the authorization data is received, detecting, using the detector 203, a present characteristic 632 of present power received at the power interface 201; and storing, in a memory 222, the present characteristic 632 as an authorized characteristic 832.

Furthermore, the deny-authorization process 260 may be implemented as a multi-step process including, but not limited to: a first step in which the controller 220 locks the device 101, and the like; a second step in which the controller 220 provides an option to authorize a new location using a characteristic of power received by the power interface 201 at the location; and a third step that is implemented if authorization of the new location does not occur to ensure that data 242 at the memory 222 is not accessible.

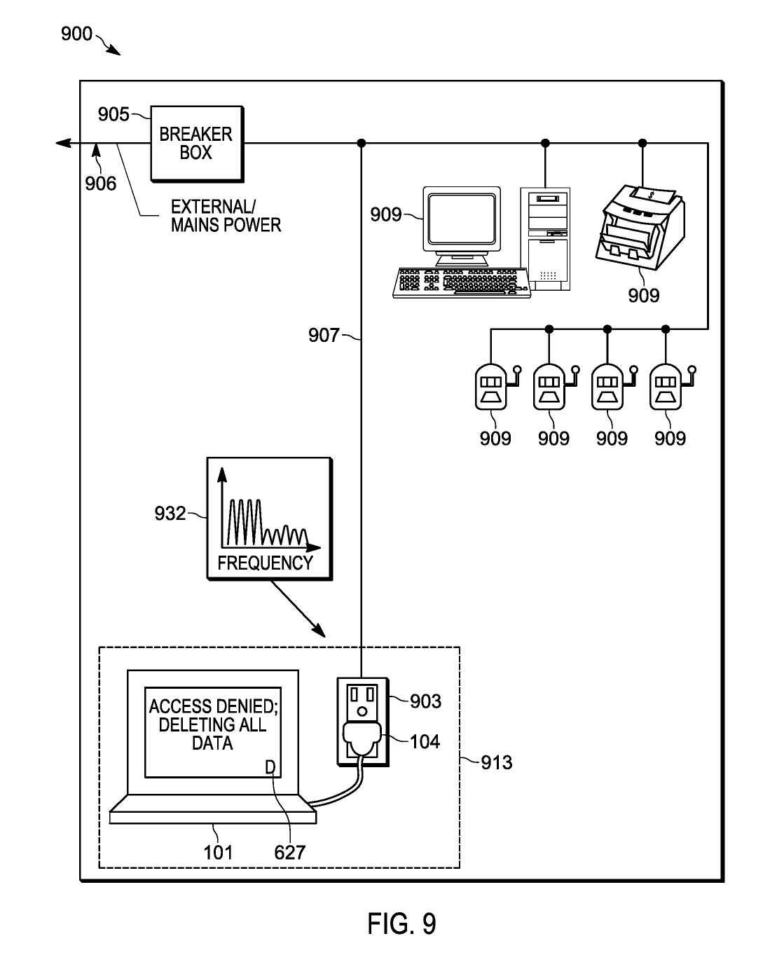

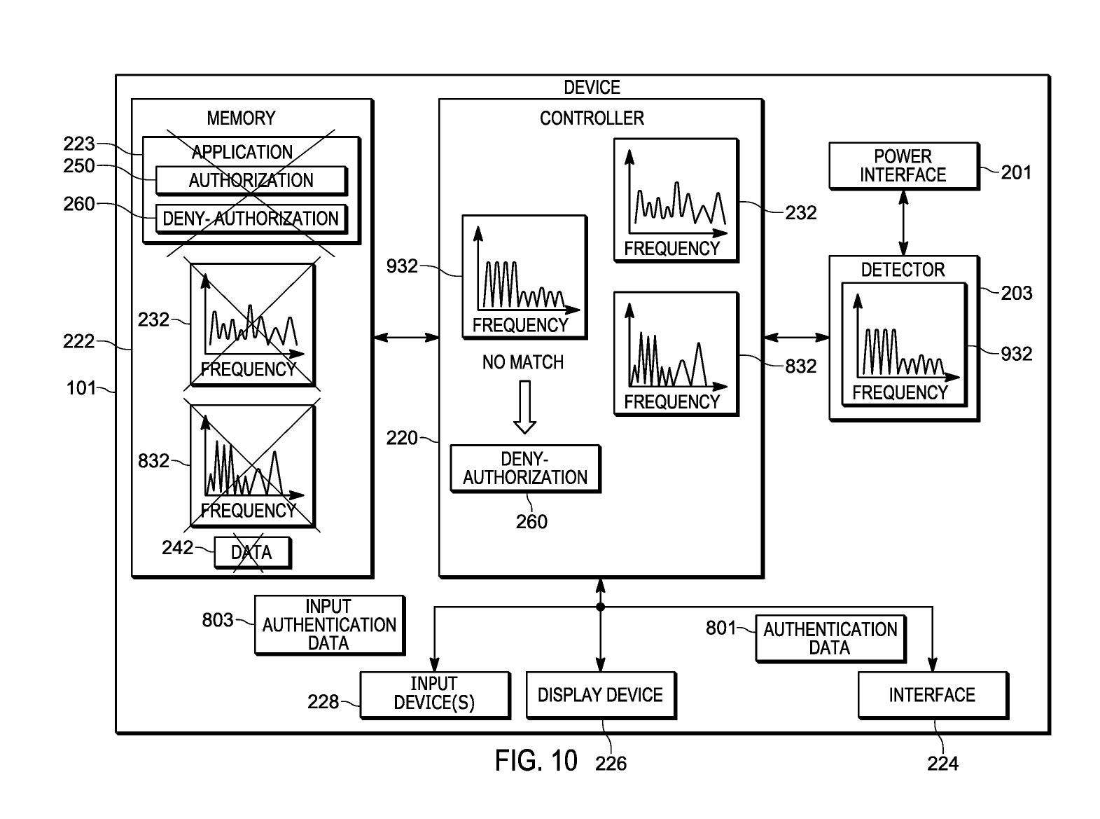

For example, attention is next directed to FIGS. 9 and 10, which depict yet a further embodiment of the blocks 302, 304, 308 of the method 300. FIG. 10 is substantially similar to FIG. 2 with like elements having like numbers.

In FIG. 9, the device 101 has been stolen and transported to another location 900, for example a location used by a malicious user. The device 101 is plugged into a power outlet 903 (e.g. via the plug 104 and the associated cable) that is connected to a breaker box 905 via electrical wiring 907 in the location 900, and furthermore the breaker box 905 is connected to an external power source 906, for example a mains power source. Furthermore, various electrical devices 909 in the location 900 are also receiving power from the external power source 906 via the electrical wiring 907. As depicted, the electrical devices 909 include a personal computer, a money counter, and slot machines, however any other electrical device that may be powered by electrical wiring and/or an external power source is within the scope of present embodiments.

Furthermore, in FIG. 9, the device 101 has been stolen and placed in a Faraday Cage 913 to prevent the device 101 from transmitting alerts and/or notifications in its present location, for example to a security server.

As also depicted in FIG. 9, the external power source 906 is associated with a characteristic 932 which is different from the authorized characteristics 232, 932. In other words, at the location 900, the devices 909, as well as the electrical wiring 907, cause the characteristic 632 to be different from the characteristics 132, 632 at the respective locations 100, 600. Furthermore, as compared to the locations 100, 600, the location 900 is missing an emitter device.

Regardless of being in the Faraday Cage 913, which generally prevents wireless signals from being successfully transmitted by the device 101 and/or received at the device 101, the characteristic 932 is received at the power interface 201 via the outlet 903, and detected by the detector 203, as depicted in FIG. 10. Indeed, even if the external power source 906 were also located in the Faraday Cage 913, the characteristic 932 would be different from the authorized characteristics 232, 832.

As also depicted in FIG. 10, the controller 220 compares (e.g. at the block 304 of the method 300) the characteristic 932 with the authorized characteristics 232, 832 and determines that a match does not occur. Hence, the controller 220 implements the deny-authorization process 260.

Presuming that any one-time password challenges (e.g. as depicted in FIG. 6 and FIG. 8), and the like, have failed, the controller 220 may implements the deny-authorization process 260 (e.g. in a multi-step deny-authorization process) by one or more of: turning off the device 101; erasing the memory 222 of the device 101; wiping a hard-drive of the device 101; and encrypting data at the device 101 (e.g. the data 242, if not already encrypted), and/or denying access to one or more of a given function, a given feature and a given application.

In particular, as depicted, the controller 220 deletes the sensitive data 242, the authorized characteristics 232, 832 and the application 223 (e.g. as represented in FIG. 10 by a respective “X” through each of the sensitive data 242, the authorized characteristics 232, 832 and the application 223). The device 101 may then turn off

In this manner, at least the sensitive data 242 is not available to a malicious user and/or criminal user that has stolen the device 101. Furthermore, by deleting the authorized characteristics 232, 832 and the application 223, such malicious users may not be able to transport the device 101 back to the locations 100, 600 to gain access to the device 101. Indeed, in yet further embodiments, the controller 220 may entirely erase the memory 222 to “brick” the device 101, thereby rendering the device 101 useless.

Described herein is a device and method for power source based device authentication in which characteristics of power received at a power interface are used to authorize access to a device, or deny authorization to access a device. An authorized characteristic of an external power source, a so-called electrical “fingerprint” may be provisioned at the device; when the device is plugged into an external power source, the device detects a characteristic of the external power source and compares it with the authorized characteristic. When a match is found, an authorization process is implemented and access to the device is granted. When a match is not found, a deny-authorization process is implemented and access to the device is not granted; in some embodiments, data at the device is deleted and/or encrypted. Furthermore, in some embodiments, when the device may operate on battery power, the device may require that it be coupled to an external power source, at least upon startup and/or periodically.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In this document, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A device comprising:
a power interface configured to receive power from an external power source;
a detector coupled to the power interface, the detector configured to detect a characteristic of the power received by the power interface; and
a controller coupled to the detector, the controller configured to:
when the characteristic of the power matches an authorized characteristic, implement an authorization process to provide access to the device; and
when the characteristic of the power does not match the authorized characteristic, implement a deny-authorization process to deny access to the device.

2. The device of claim 1, further comprising a memory coupled to the controller, the memory configured to store the authorized characteristic.

3. The device of claim 1, the controller further configured to determine the authorized characteristic by:
receiving, using an input device, authorization data to provide access to the device;
when the authorization data is received, detecting, using the detector, a present characteristic of present power received at the power interface; and
storing, in a memory, the present characteristic as the authorized characteristic.

4. The device of claim 1, wherein the detector comprises one or more of: a signal detector, a current detector, a voltage detector, a power detector, and a spectrum analyzer.

5. The device of claim 1, wherein the authorized characteristic comprises one or more of: a given electrical signal present in the power, a current pattern of the power, a voltage pattern of the power, and a frequency pattern of the power.

6. The device of claim 1, wherein each of the characteristic and the authorized characteristic is a function of time.

7. The device of claim 1, wherein each of the characteristic and the authorized characteristic include an indication of one or more of a type and an identifier associated with the external power source.

8. The device of claim 1, wherein the controller is further configured to determine the characteristic by:
using the detector to perform a plurality of detections; and
averaging respective characteristics of the power detected by the detector in each of the plurality of detections.

9. The device of claim 1, wherein the deny-authorization process comprises one or more of:
the controller locking the device;
the controller turning off the device;
the controller erasing a memory of the device;
the controller wiping a hard-drive of the device;
the controller encrypting data at the device;
the controller providing a notification of an unauthorized location;
the controller denying access to one or more of a given function, a given feature and a given application; and
the controller controlling a notification device to request authorization data.

10. The device of claim 1, wherein the controller is configured to repeat comparing the characteristic with the authorized characteristic to repeat a determination of whether to implement the authorization process or the deny-authorization process.

11. A method comprising:
receiving, at a controller of a device, a characteristic of power, the characteristic received from a detector coupled to the controller and a power interface, the detector configured to detect the characteristic of the power received by the power interface from an external power source, the device comprising the controller, the detector and the power interface;
when the characteristic of the power matches an authorized characteristic, implementing, using the controller, an authorization process to provide access to the device; and
when the characteristic of the power does not match the authorized characteristic, implementing a deny-authorization process to deny access to the device.

12. The method of claim 11, wherein the authorized characteristic is stored at a memory of the device, the memory coupled to the controller.

13. The method of claim 11, further comprising determining the authorized characteristic by:
receiving, using an input device, authorization data to provide access to the device;
when the authorization data is received, detecting, using the detector, a present characteristic of present power received at the power interface; and
storing, in a memory, the present characteristic as the authorized characteristic.

14. The method of claim 11, wherein the detector comprises one or more of: a signal detector, a current detector, a voltage detector, a power detector, and a spectrum analyzer.

15. The method of claim 11, wherein the authorized characteristic comprises one or more of: a given electrical signal present in the power, a current pattern of the power, a voltage pattern of the power, and a frequency pattern of the power.

16. The method of claim 11, wherein each of the characteristic and the authorized characteristic is a function of time.

17. The method of claim 11, wherein each of the characteristic and the authorized characteristic include an indication of one or more of a type and an identifier associated with the external power source.

18. The method of claim 11, further comprising determining the characteristic by:
using the detector to perform a plurality of detections; and
averaging respective characteristics of the power detected by the detector in each of the plurality of detections.

19. The method of claim 11, wherein the deny-authorization process comprises one or more of:
locking the device;
turning off the device;
erasing a memory of the device;
wiping a hard-drive of the device;
encrypting data at the device;
providing a notification of an unauthorized location;
denying access to one or more of a given function, a given feature and a given application; and
controlling a notification device to request authorization data.

20. The method of claim 11, further comprising repeating comparing the characteristic with the authorized characteristic to repeat a determination of whether to implement the authorization process or the deny-authorization process.
